(19) United States
(12) Patent Application Publication
(10) Pub. No.: US 2020/0386668 A1
(43) Pub. Date: Dec. 10, 2020

(54) FLEXIBLE SENSOR SYSTEM

(71) Applicant: iButtonLink, LLC, Whitewater, WI (US)

(72) Inventors: Robert Erick Olson, Arlington Heights, IL (US); Joseph Anthony Komlodi, Madison, WI (US)

(73) Assignee: iButtonLink, LLC, Whitewater, WI (US)

(21) Appl. No.: 16/848,477

(22) Filed: Apr. 14, 2020

Related U.S. Application Data
(60) Provisional application No. 62/834,818, filed on Apr. 16, 2019.

(51) Int. Cl. G01N 17/04; G01K 7/02; G01N 25/66; F24F 11/32; G08B 5/36

(52) U.S. Cl. CPC G01N 17/04; G01K 7/02; G08B 5/36; F24F 11/32; G01N 25/66

(57) ABSTRACT

A method and system including an architecture to build a sensor device, data logger device, or network of sensor and/or data logger devices such that each element of the device or network contains all the information, including configuration information, commands, timing information, and math needed for higher-level elements to it without any configuration, software, firmware, or driver changes or updates required for the higher-level elements. This allows introduction of new devices or sensors in a simple plug-and-play manner. Derived sensors and alarms may act as independent devices that contain all of the information needed to extract data from lower-level sensors and perform math on it to produce results that appear to higher levels as though the derived sensor was itself a physical sensor.

This application is related to, and claims priority to, U.S. Provisional Patent application No. 62/834,818 filed Apr. 16, 2019. Application 62/834,818 is hereby incorporated by reference in its entirety.

### BACKGROUND

### Field of the Invention

The present invention relates to the field of sensors and more particularly to a system of flexible and networked sensors.

### Description of the Problem Solved

Present-day sensors and data loggers are designed as a single device that works with an established protocol to communicate data over a sensor network to the user without sharing detailed configuration information. The present designs required that when a new device, such as a new type of physical sensor element, is introduced to the system, all parts of the system that interact with the data from that element must be updated with new firmware, software, drivers, or configuration tables. For instance, sensors built with the state-of-the-art BACnet protocol communicate the type of physical phenomenon sensed using a coded table embedded in the standard, which is only updated every few years. In the BACnet environment, introducing a sensor that measures a new type of physical phenomenon requires updating firmware on the sensor or data logger to which the element is attached, the BACnet network controller software, any user display software, and the standard itself. In another example, a networked sensor system may transmit data in a packet format that has a standardized packet layout and sensor-type encoding system that prevents a new physical sensor type, or new feature such as a higher resolution temperature reading, to be added to a cellular data logger without a firmware change to the cellular data logger and changes to every part of a sensor network or application that uses the data from the data logger.

### SUMMARY OF THE INVENTION

The present invention relates to the field of sensors and more particularly how sensors are designed and networked. The invention is a method and system including an architecture to build a sensor device, data logger device, or network of sensor and/or data logger devices such that each element of the device or network contains all the information, including configuration information, commands, timing information, and math needed for higher-level elements to it without any configuration, software, firmware, or driver changes or updates required for the higher-level elements. This invention may also be used in other fields, such as the field of heating and air conditioning air handling units which are not strictly sensors but must be controlled in a similar manner via a multipart firmware and software architecture.

Several key concepts of the invention are:
1. Elements in a device, such as a data logger or sensor, are considered separately during design and may be considered separately during assembly and inventory storage, such as a data logger being considered a combination of one or more physical sensor elements, one or more data-logging elements, and one or more interface elements used for communication with other elements or external devices.
2. Elements in a single device are considered in a hierarchical structure.
3. Machine-readable configuration(s) is/are embedded in each element that is/are exposed to the element(s) at the next higher level in the hierarchy, which contains at least one of the following:
   a. Machine-actionable command(s) embedded in each element that is/are exposed to the element(s) at the next higher level in the hierarchy.
   b. Machine-actionable math formula(s) and/or table(s) embedded in each element that is/are exposed to the element(s) at the next higher level in the hierarchy.
4. The concept a derived sensor, which is a sensor derived from a combination of physical sensor values, other derived sensor values, historical sensor data, multiple values from a physical sensor, inputs of any type, or some combination thereof
5. A network of devices may be viewed as a single device, where devices in the network may perform the functions necessary of the components of a single physical sensor or data logger.

### BRIEF DESCRIPTION OF THE DRAWINGS

Attention is now directed to several figures that illustrate features of the present invention:

FIG. 1 illustrates an overview of connections for a typical low-power data logger with multiple physical sensor elements, a data-logger element, and an interface element as it would be designed in embodiments of the present invention.

FIG. 2 illustrates a simple physical analog sensor element according to the present invention.

FIG. 3 illustrates a simple I2C sensor as it would be designed according to the present invention.

FIG. 4 illustrates a complex physical sensor element that must have local processing due to complex math, the shielding of proprietary algorithms, critical timing for which the interface is too slow, or other reasons as it would be designed according to the present invention.

FIG. 5 illustrates a specific and detailed layout of a data logger working with I2C-based physical sensor elements as it would be designed according to the present invention.

FIG. 6 illustrates a specific layout of an interface element for a data logger as it would be designed according to the present invention.

FIG. 7 illustrates the power layout of a cellular data logger device as it would be designed according to the present invention.

FIG. 8 is a block diagram of a USB data logger designed according to the present invention denoting client and server relationships between elements.

FIG. 9 illustrates a network of sensors comprised of multiple 1-Wire® sensors according to the present invention.

FIG. 10 illustrates a network of sensors including one or more data loggers or sensors connected to an Internet or cloud server/database via cellular, WiFi, Ethernet, or similar connection medium according to the present invention.

Several drawings and illustrations have been provided to aid in understand the present invention. The scope of the present invention is not limited to what is shown in the figures.

### DETAILED DESCRIPTION OF THE PREFERRED EMBODIMENTS

The present invention relates to the field of sensors and more particularly how sensors are designed and networked. The invention is a method, system, and architecture to build a hierarchical sensor device, data logger device, or network of sensor/data logger devices such that each element of the hierarchy contains all the information, including configuration information, commands, timing, math, and parameters of the provided value needed for higher-level elements to it without any configuration, software, firmware, or driver changes or updates required for the higher-level elements.

Some of the key concepts of the invention are:
1. Elements in a device such as a data logger or sensor are considered separately during design and may be considered separately during assembly and inventory storage, such as a data logger being considered a combination of physical sensor elements, a data logging element, and an interface element, which communicates with the outside world.
2. Elements in a single device are considered in a hierarchical structure.
3. Machine-readable configuration(s) embedded in each element that is/are exposed to the element(s) at the next higher level in the hierarchy, which contains at least one of the following:
   a. Machine-actionable command(s) embedded in each element that is/are exposed to the element(s) at the next higher level in the hierarchy.
   b. Machine-actionable math formula(s) and/or table(s) embedded in each element that is/are exposed to the element(s) at the next higher level in the hierarchy.
4. The concept a derived sensor, which is a sensor derived from a combination of physical sensor values, other derived sensor values, historical sensor data, multiple values from a physical sensor, inputs of any type, or some combination thereof.
5. A network of devices may be viewed as a single device where devices in the network may perform the functions necessary of the components of a single physical sensor or data logger.

### Structure

The present invention organizes the elements of an individual device into a hierarchical structure. The present invention views the elements of a network of devices as a hierarchical structure, even though the network of devices may be a mesh or other non-hierarchical configuration. The structural concepts between the elements of an individual device and a network of devices are the same. The term “element” is used to interchangeably describe the parts that make up a single device and the devices that make up a network of devices. In the current invention, a device may be a single physical device or a group of physical devices that are connected, or networked, such that the collective devices may function as a single cohesive unit.

In this description of the present invention, the terms “client” and “server” are used to describe how elements interact. Client elements consume data and configuration information from servers. Server elements produce configuration information and data for clients. An element may be a client, a server, or both.

Client elements are said to be higher in the hierarchy than a server from which they consume data and configuration information. Server elements are lower in the hierarchy than the client that may request data from it. Generally, a client element requests data and configuration information from a server one level lower in the hierarchy; however, this is not a requirement. A client element may request data or information from other levels. A client requesting data or information from any other level is within the scope of the present invention.

An element may be a server such that the element provides data and configuration information for client elements. An element may be a client element that consumes information and configuration information from other elements. An element may be both a client and server, where it may consume configuration information and data from one or more elements and provide configuration information and data to one or more other elements in the hierarchy.

Depending on the protocol or connection method used between two elements, the client may initiate and control information exchange, or the server may do so. The use of the term “client” or “server”, or the hierarchical nature of the elements, does not constrain the method of information exchange between elements.

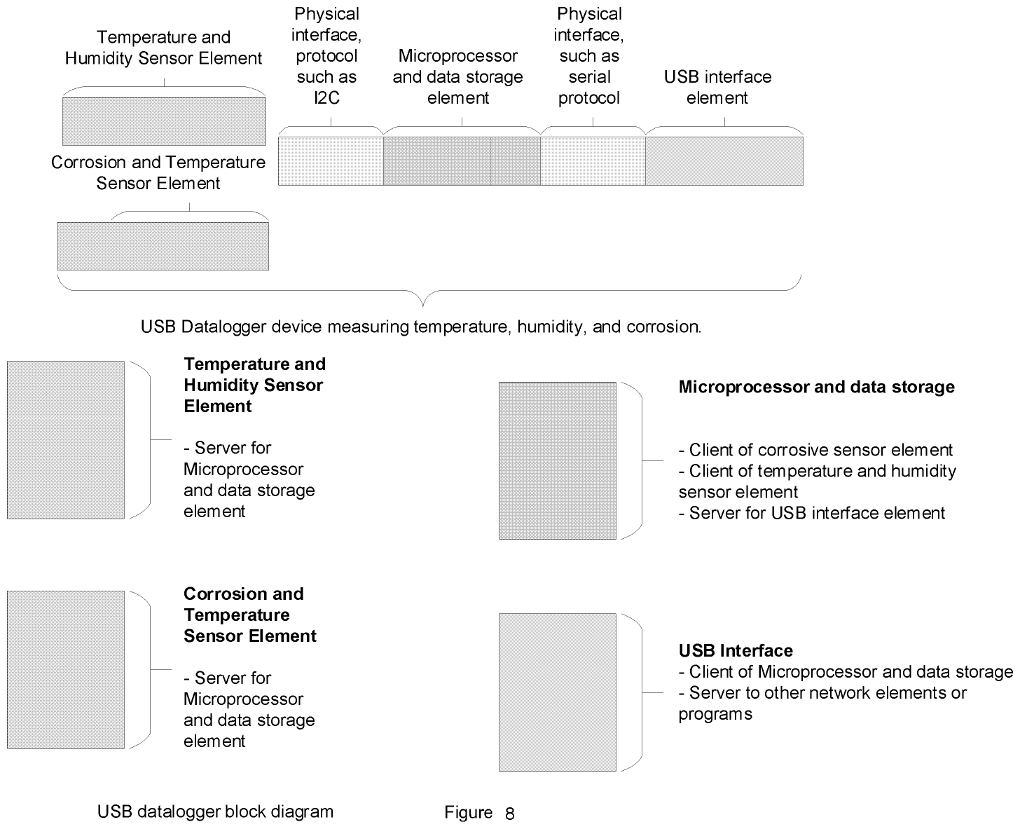

In a particular embodiment of the hierarchical concept of a device shown in FIG. 8, a data logger device is comprised of four elements: 1) a USB interface element, 2) a microprocessor and data-storage element, 3) a corrosion and temperature sensor element, and 4) a temperature and humidity sensor element. In this embodiment, the USB interface element is a client of the microprocessor and data storage element; the microprocessor and data storage element is a server for the USB interface element and a client for both sensor elements; the corrosion and temperature sensor element is a server for the microprocessor and data-storage element; and the temperature and humidity sensor element is a server for the microprocessor and data-storage element.

### Segmented Elements

Parts of a physical device or network designed according to the present invention are considered separate elements rather than parts of the whole. Each of the separate elements may be designed separately and then connected in a hierarchy such that each element is either a client element, a server element, or both.

The separate elements of the device or network are considered during the design stage. Each element may be designed independently and must contain all information necessary for client elements to use the element as a server.

The elements of a device or network are considered interchangeable if they may each be a server for the same client part of the device or network.

### Self-Defined Elements

Each element in a device or system contains the configuration information necessary for client devices to make use of it. The configuration may include the commands and timing necessary to actuate parts of the element and/or the math necessary to perform certain functions with the results from the element. These concepts are detailed later in this description. Each element of a device uses a machine-readable description language that describes the element in detail. A particular machine-readable description language is based on the JSON language; however other syntaxes and methods may be used other than JSON with equal effectiveness. Any machine-readable description language is within the scope of the present invention.

A typical example of the description of a physical sensor element may include the following and other information:
1. How to talk to the sensor element, including I2C commands to initialize the sensor, start a sensing cycle, and capture data;
2. Timing requirements (warm up, read time, cool down) and current requirements;
3. Sensor type, data available, and data ranges
4. Sensor math needed by a data logger;
5. Other commands, such as LEDs and alarm outputs;
6. A priority in which commands may be safely executed for best results;
7. Calibration tables, calibration formulas, and calibration information such as the calibration provider, calibration type, uncertainties, calibration date, and calibration expiration date; and
8. Sensor model numbers, serial numbers, manufacturer, manufacture dates, warranty dates, and other business-related information.

Some items in the list of configuration information is common to prior art sensor systems, such as a serial number or a model. However, other parts are unique to the present invention. Two such unique parts are embedded commands that may be acted upon by clients and math in the form of formulas and/or tables that allow a client to interpret a result. By providing these two unique types of information a client does not need new software, firmware, drivers, configuration files, or setup to use a server element even if the server element was not considered when the client element was created. Further, a device made of elements with this level of description may be plugged together without any setup or configuration whatsoever.

A server component including a machine-readable self-description is necessary, but typically not sufficient to complete all tasks. The server typically needs to include machine-actionable commands and math formulas that allow a client to execute commands on the server. The commands that must be performed for the server to function are defined such that a client may perform the command sequences. Example commands include a command to trigger an element to read the value of a physical sensor; retrieve the value read from the physical sensor; put the element to sleep; power the element up; configure the element to log data over a period of time at a certain interval; and configure a device to alert the client device when an out-of-range value is detected.

In a particular embodiment, a sensor element, output device, or other element, which is a server for a data logger engine, exposes I2C commands embedded in JSON that allow the data logger engine to command the sensor component to take certain actions. These actions may include, but are not limited to, turning on or off an LED; telling a physical sensor to make a reading; retrieving data from the sensor; turning on or off a heater located on the sensor; and configuring an out-of-range alarm on the sensor. These actions may be physical actions, such as turning the LED on/off, or having the sensor make a reading. The actions may also retrieve data, and/or configure the sensor, such as setting the alarm threshold values.

An example of a command sequence that can be stored in the configuration of a physical temperature sensor element to cause the sensor to read the temperature is:
“force-conversion”: “+w80F3−”,
“conversion-time”: 11,
“read-conversion”: “+r8002]−”,
“conversion-energy”: 4841,

This example shows that two commands must be executed over an I2C interface with at least an 11 mS delay between the execution of the first and second command. The commands will require 4,841 micro-amp milliseconds of energy to complete.

An additional element of the command system can be a signal processing definition that enables a client to execute commands on a master using looping and control structures, such as “if statements”.

The following is an example of a signal-processing configuration for a high-resolution temperature sensor that may be included, along with additional configuration information, in the physical temperature sensor element provided above.
“force-conversion”: “+w80F3−”,
“conversion-time”: 11,
“read-conversion”: “+r8002]−”,
“signal-process”: “p3 b0.7+p2 b10.15+p5 15<? 1+: p2 rc4.3 f p5 0 e p2 0 e p3 0 e;”,

The above example allows the client to execute a loop that reads the temperature sensor 16 times using the provided I2C commands and average the result. The example uses a counter variable in register p5 for the loop; stores data in register p2 and p3, which may overflow into register p4; and a cascading bit shift operation in registers p2-p4. The signal-processing functions of the command section may perform math functions on the values. There may also be a separate formula in the sensor configuration. In the example above, if both are present, the signal processing is performed first, and the formula is performed on the result of the signal processing.

The command system includes a method to sequence commands in a required order, or hierarchy. It is common that commands must be performed in order to receive correct results. The action hierarchy guarantees that actions will happen in the intended sequence.

In a particular embodiment, a sensor component, which is a server for a data logger engine, exposes the required sequence of commands to perform sensor readings and math functions. For example, a temperature and humidity component may require that for a humidity to be accurately sensed, the client must first request that a temperature be sensed. Further, only after both the temperature and humidity are sensed, retrieved, and calculated, may dew point be calculated. In this case the action hierarchy would indicate that temperature must occur before humidity and that humidity must occur before a dew point calculation.

### Math System

The math system allows a client to perform mathematical calculations on configuration data, sensor data, or other data provided by the server.

In a particular embodiment, a sensor component, which is a server for a data logger engine, exposes math formulas that allow the data logger engine client to convert the raw sensor readings retrieved into a useful value, such as a temperature in degrees Celsius. The sensor component may also expose math sequences or lookup tables that allow the client to adjust the value using data from a previous calibration.

The following is an example of the math stored in the configuration of a physical temperature sensor element to cause the sensor to read the temperature:
“conversion-formula”: “172.72 b0.7 256*b8.15+*65536/46.85−”,
“data-bytes”: 2,
“frac-bits”: 7,
“adc-bytes”: 2,
“units”: “° C.”,
“resolution”: 0.01,
“absolute-min”: −40,
“absolute-max”: 85,
“safety-min”: −45.0,
“safety-max”: 115.0

This example shows the math formula to be computed; the data layout; the units of the finished result; the resolution of the finished results; the maximum and minimum values, which are specified for the sensor; and the maximum and minimum safe values over which the sensor can compute values.

### Derived Sensors

The machine-actionable math system and machine-actionable command system, when coupled with a prerequisite and priority system, allow a sensor value to be derived rather than be obtained from a direct physical reading. The sensor may be derived from any of the following:
1) Multiple readings of a single sensor in a short period of time, such as using an appropriate averaging method to create a higher-resolution temperature sensor from multiple samples of a lower-resolution physical sensor.
2) Readings of more than one sensor that are combined to derive new information, such as calculating a dew point from a temperature sensor value and a relative humidity sensor value.
3) A time series of values from one or more sensors that may be stored in a log or cache, such as to compute the temperature of insulin in a bottle using a time series of physical temperature measurements of the air surrounding the bottle or calculating the number of degree hours that the same bottle of insulin is out of the recommended temperature range. This log or cache may be stored in a physical sensor element or in a client to the physical sensor element, such as a datalogging microprocessor.
4) Adjusting the value of one sensor by using the value of another, such as temperature-sensor information used to correct a conductance measurement made on a thin film of metal.
5) Adjusting the value of sensor by using a constant stored in the sensor configuration using a formula such as calculating a temperature from the voltage of a thermocouple.
6) Adjusting the value of a sensor using a table lookup such as a calibration table.
7) A combination of the above methods.

In all cases, the calculations may be made using readings from physical sensors or other derived sensors. Therefore, complex systems may be created by deriving a sensor value from other derived sensor values. Derived sensors may be created by providing only the math necessary to compute a new sensor value from prerequisite sensors, or a derived sensor may contain commands to physical sensors and math to allow the execution of one or more physical sensor commands, as well as the math necessary to calculate a new value.

The present invention includes a set of required prerequisites of physical and derived sensors to determine the order in which sensors must be read and/or calculated. The configuration stored in each physical and derived sensor contains a set of values that indicates what prerequisites must be completed before this physical or derived sensor may be operated upon and a separate set of values of what this physical or derived sensor provides as prerequisites for use in calculations of other physical and derived sensor values.

In a particular embodiment of a small USB data logger with one physical sensor element, the prerequisite values are implemented as two bit fields; however, other implementations that perform the same basic functions may be appropriate for other sensor or network designs where values from multiple devices, or elements, must be considered.

In this embodiment, which includes a physical temperature sensor, a physical humidity sensor, a derived high resolution temperature sensor, and a derived dew point sensor, the following prerequisite requirements are encoded: the temperature sensor requires no prerequisites; the high-resolution temperature sensor needs no prerequisites; the humidity sensor requires no prerequisites; the dew point sensor requires the humidity sensor as a prerequisite and either the high-resolution temperature sensor or physical temperature sensor as a prerequisite.

In this embodiment, which includes a physical temperature sensor, a physical humidity sensor, a derived high resolution temperature sensor, and a derived dew point sensor, the following is prerequisites are supplied and thus encoded: the temperature sensor satisfies a prerequisite where its value is needed; the high-resolution temperature sensor provides a prerequisite where its value is needed and satisfies the prerequisites for the physical temperature sensor value; the humidity sensor satisfies a prerequisite where its value is needed; and the dew point sensor satisfies a prerequisite where its value is needed (even though in this example, there is no other sensor requiring dew point).

It is noted that the high-resolution temperature sensor is a derived sensor, which, in this embodiment, samples the physical temperature sensor sixteen times, other number of times, and then averages the result. However, the high-resolution temperature sensor does not list the physical temperature sensor as a prerequisite, because the derived high-resolution temperature sensor includes a command definition to collect the sixteen physical sensor values separately. In contrast to the derived high-resolution temperature sensor, the dew point derived sensor contains only the formula needed for dew point computation and requires prerequisite values from other physical sensors. Both methods of creating derived sensors, with and without embedded physical commands, are equally valid and are within the scope of the present invention. The data logger microprocessor element, which is a client to the physical sensor in this example, may be requested to provide dew point values by the interface element, which is a client of the microprocessor. If so, the data logger microprocessor would use the prerequisite information stored on the physical sensor element to determined that first the physical temperature or the high-resolution temperature must be evaluated including any commands or math found in the physical sensor element configuration; the physical humidity sensor must be evaluated including any commands or math found in the physical sensor element configuration either before, after, or at the same time as either temperature sensor; then finally the dew point may be computed using the math in the physical sensor element configuration.

When cases arise that two or more values may be computed in any order, such as in this case where either temperature value and the humidity value may be executed at the same time, a priority order can be applied to ensure the operations are consistent and executed in the same order. In more complex implementations, this priority order may be adjusted to allow multiple threaded operations to occur simultaneously.

In the dew point example, the temperature must be read first from a physical sensor; the relative humidity value is then read from a physical sensor. The relative humidity value may then need to be corrected using the temperature sensor reading, and finally, the temperature value and humidity value are used to calculate the dew point. Each step is defined in the configuration as a configuration for a sensor value with a priority order.

A derived sensor exposed by a server is self-described as is a physical sensor even though no physical sensor element exists. Instead of executing physical commands to retrieve the sensor data, the client is presented a set of math formulas and/or lookup tables that calculate a new sensor value from existing physical readings.

In one example, a temperature and humidity sensor component, which is a server for a data logger engine, exposes a dew point derived sensor. The dew point derived sensor contains all the configuration information for a sensor as if it were a physical sensor; however, the dew point sensor value is a math function based on physical temperature and humidity values. There is no physical dew point sensor, only a derived sensor made from a math function.

In one example, a corrosion sensor component, which is a server for a data logger engine, exposes three sensors: a physical temperature sensor, a physical voltage sensor, and a derived corrosion sensor. The derived corrosion sensor value is calculated from the voltage reading across an element, the temperature of the sensor, and a set of lookup tables and formulas.

The following example shows an implementation of a physical temperature sensor and a derived high-resolution temperature sensor configuration that samples the physical sensor sixteen times and calculates the higher resolution result. These example configurations are stored in a single physical sensor element to provide two separate temperature sensor values, one physical and one derived.

Example of a derived high-resolution temperature sensor configuration

```
“{
  “mode 2” : {
  “force-conversion”: “+w80F3-”,
  “conversion-time”: 11,
  “sensor-type”: “High res temperature sensor”,
  “read-conversion”: “+r8002]-”,
  “frac-bits” : 7,
  “conversion-formula”: “172.72 b0.7 256 * b8.15 + * 65536 / 46.85 -”,
  “priority-required”: 0,
  “priority-set”: 6,
  “priority” : 1,
  “primary-bit” : 4,
  “data-bytes” : 6,
  “adc-bytes” : 2,
  “signal-process” : “p3 b0.7 + p2 b10.15 + p5 15 < ? 1 + : p2 rc4.3 f p5
0 e p2 0 e p3 0 e;”,
  “units”: “°C”,
  “resolution”: 0.003,
  “absolute-min” : −40,
  “absolute-max” : 85,
  “conversion-energy” : 77455,
  “safety-min” : −45.0,
  “safety-max” : 115.0
  }}\0”
```

### Example of the Configuration of a Physical Sensor Element in the Same Physical Sensor Element as the Derived High-Resolution Temperature Sensor.

```
“{
  “mode 3” : {
  “force-conversion”: “+w80F3-”,
  “conversion-time”: 11,
  “sensor-type”: “Temperature sensor”,
  “read-conversion”: “+r8002]-”,
  “frac-bits” : 7,
  “conversion-formula”: “172.72 b0.7 256 * b10.15 + * 65536 / 46.85 -”,
  “priority-required”: 0,
  “priority-set”: 2,
  “priority” : 2,
  “primary-bit” : 2,
  “data-bytes” : 2,
  “adc-bytes” : 2,
  “units”: “°C”,
  “resolution”: 0.01,
  “absolute-min” : −40,
  “absolute-max” : 85,
  “conversion-energy” : 4841,
  “safety-min” : −45.0,
  “safety-max” : 115.0
  }}\0”
```

The above example demonstrates the following concepts of the present invention: force-conversion, conversion-time, and read-conversion. These are examples of embedded commands with timing information. Conversion-formulas show an example of embedded math, and the priority fields show an implementation of the prerequisite and priority system. The examples also show the implementation of the parameters required to use the data provided by the sensor, even if the unit type is not defined in the client device. The examples also show the implementation of protections from under and over range, energy usage information to enable the client to make energy efficient choices.

### Complex Alarms

Physical or derived sensors may be used to construct an Alarm, which is a special case of a derived sensor. A derived sensor may be used in logic equations to trigger that specific events should occur. An Alarm may contain additional command(s) and/or signal-processing configuration information that is only executed when the final value of the Alarm-derived sensor matches a conditional value.

Alarms may be simple, such as a derived sensor that compares the value of a physical temperature sensor with a maximum value outputting a Boolean true, represented by a non-zero result if the physical temperature sensor value is greater than the maximum value and a Boolean false, represented by a zero result otherwise.

A simple Alarm is described in the example below, which determines if a temperature has exceeded 0 degrees C. The Alarm fetches a previously computed value. The value is then compared to zero. If found to be greater than zero, a log entry is recorded with a timestamp and the value measured.

```
“{
  “mode 4” : {
  “sensor-type”: “ Overtemperature alarm”,
  “frac-bits” : 7,
  “conversion-formula”: “f 3 a > ? s : ;”,
  “priority-required”: 1,
  “priority-set”: 8,
  “priority” : 8,
  “data-bytes” : 2,
  “units”: “°C”,
  “resolution”: 0.01,
  “absolute-min” : −40,
  “absolute-max” : 85,
  “safety-min” : −45.0,
  “safety-max” : 115.0
  “alarm-comparison”: 0,
“alarm-log” : “e,\”%f has exceeded %f %d\“, f3, c, t”
  }}\0”
```

This simple alarm may also refer to a variable in the client for comparison rather than a fixed value in the example, allowing more flexibility in the configuration of the alarm. An Alarm may also cause other events to occur, such as lighting an LED, or other physical alert; reading other sensor values, either derived or physical or both; recording other sensor values; causing a client to start or stop or continue datalogging for a fixed or infinite number of log entries; triggering a physical action, such as starting an air conditioner, via a relay, network command, or other means; or alerting another client device in a network. Alarms and the actions taken if an Alarm meets a condition may also be separated in a configuration.

Alarms may also be complex. A complex alarm may be computed as any other derived sensor, including using the values of multiple physical or derived sensors.

An example of a complex alarm is a derived sensor that is Boolean true, non-zero in the current implementation, if an iteration over the logged values of a corrosion sensor find that the rate of corrosion is greater than a specific limit found in a national standard. Give a data log of temperature readings with corresponding voltage readings from a metal thin film conductance sensor, the complex steps to accomplish this goal may be as follows:
1) For a pair of temperature and conductance values measured at the same time, calibrate the temperature value using a lookup table stored in the sensor configuration.
2) For each value, calculate a derived sensor that is the temperature normalized conductance measurement as if the measurement were made at 25 degrees C. using a formula and lookup table stored in the sensor configuration.
3) For each normalized conductance measurement made in step two, calculate a metal thickness value by use of a formula that uses the original thickness measurement and temperature adjusted conductance for the original thickness with both the formula and initial values stored in the sensor configuration.
4) For each derived metal thickness measurement, calculate a corrosion product thickness using a formula stored in the sensor configuration.
5) Use the time series of derived corrosion product thicknesses to compute a rate of change normalized to a 30-day moving window using a formula stored in the sensor configuration.
6) Compute the final Boolean value as true, non-zero in this implementation, if the 30-day moving average exceeds a fixed amount from the standard, which is stored in the configuration of the sensor.

Complex alarms are typically not found in prior art products due to the special coding required. In the present invention, the configuration contains all the information necessary to derive a complex Alarm function so that no special or new coding is required.

Another example of a complex Alarm-derived sensor using the machine-actionable math system is to determine if a temperature probe has been in the food temperature danger zone for two hours or more. A further example of a complex Alarm is to determine if a temperature probe has been exposed to either a peak temperature sufficient to render insulin ineffective or has been in a temperature range that will degrade insulin for enough total degree-minutes for the insulin to be rendered ineffective.

With the machine-actionable math system, the server temperature sensor may expose either simple or complex alarms to a client without a requirement that the client has any previous programming related to the Alarm function.

### Calibrations

The math system, signal-processing system, and data tables may be used in a configuration to provide all calibration information for a physical or derived sensor. Sensor values may be provided to a client uncalibrated or calibrated, as needed. An uncalibrated, or raw, sensor value may be stored in a data log and later calibrated when the value is needed by another sensor or by a client device. Additional calibration information, such as the calibration provider, uncertainty, expiration, calibration date, and calibration method, may also be included. The calibration table and other calibration information may be updated when a sensor is recalibrated.

### CONCLUSION

The present invention may be summarized by reference to several figures and drawings:

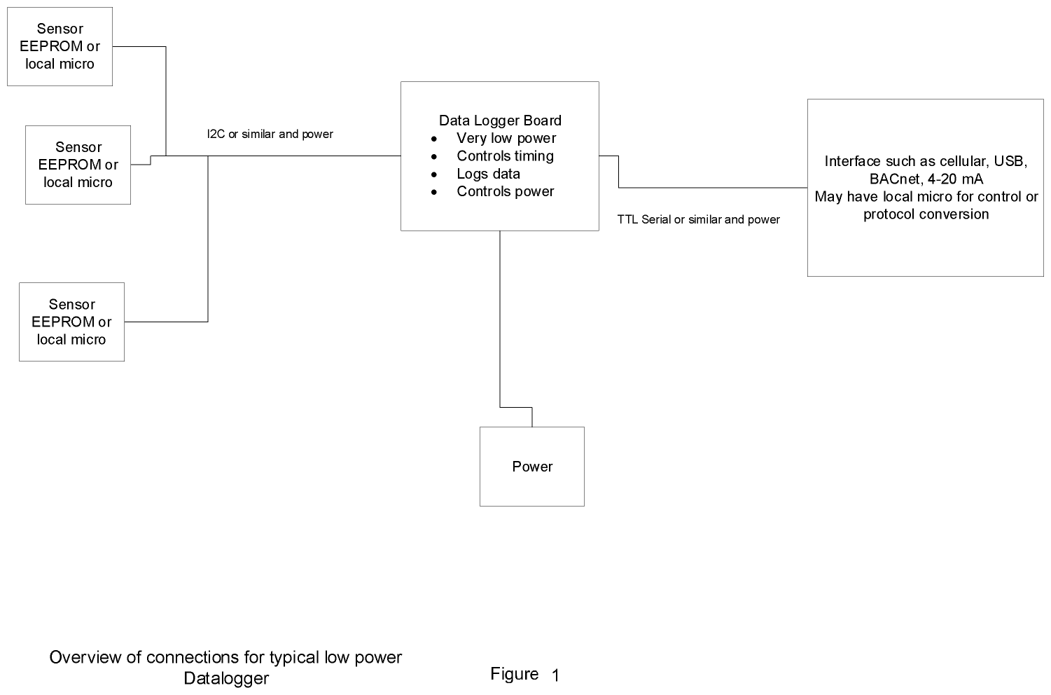

FIG. 1 shows an overview of connections for a typical low-power data logger with multiple physical sensor elements, a data-logger element, and an interface element as it would be designed in embodiments of the present invention. Several sensors, each containing electrically erasable memories (EEPROMs), microprocessors, or other local memory communicate with a data logger board. The output of the data logger board is a serial bus with an interface such as Universal Serial Bus (USB), BACnet or the like, or other interface. The sensors may be physical or derived and typically communicate with the data logger board using an I2C or similar bus.

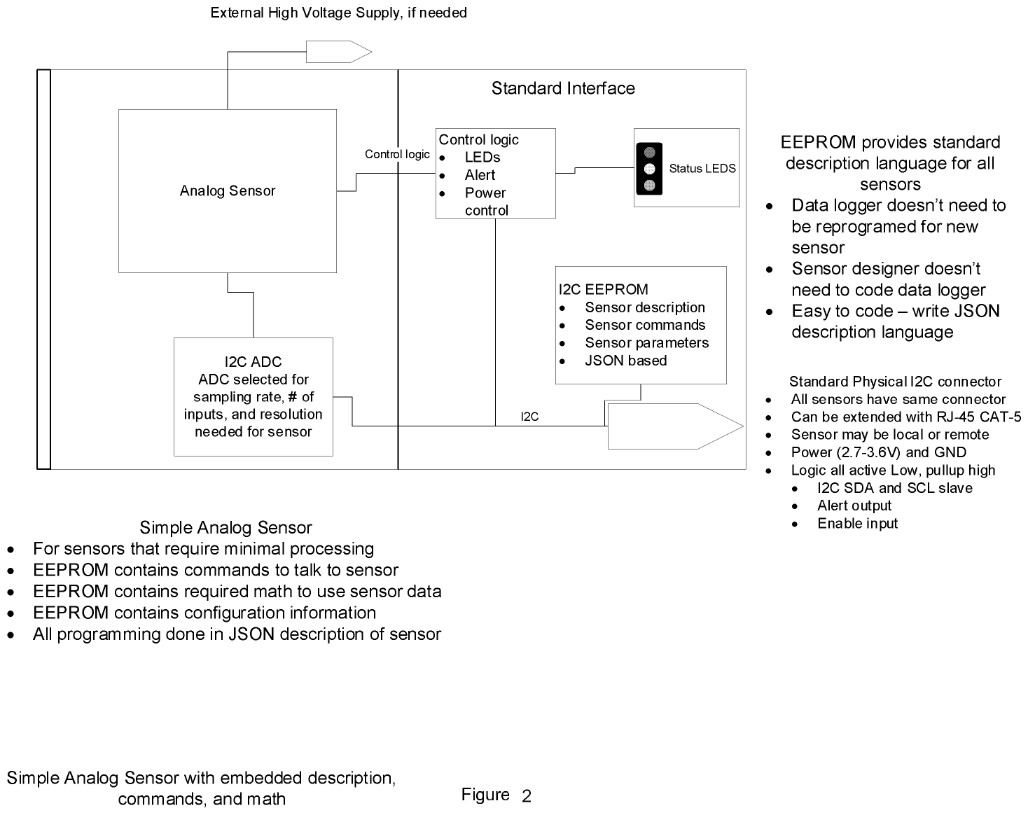

FIG. 2 shows a simple physical analog sensor element. This element can typically communicate with devices such as the data logger of FIG. 1. It includes an analog sensor, control logic and optional status Light Emitting Diodes (LEDs). In addition, there may be an Analog to Digital Converter (ADC) and an output link that typically communicates using an I2C connector. Typically all sensors have the same connector. The sensor of FIG. 2 also includes a I2C EEPROM or other electronic memory that contains a sensor description, commands and sensor parameters. For sensors that require minimal processing, a sensor EEPROM contains the commands needed for other devices to communicate with the sensor, math needed to use the sensor, and configuration information. A major feature of the present invention, is that the data logger does not need to be re-coded for different sensors.

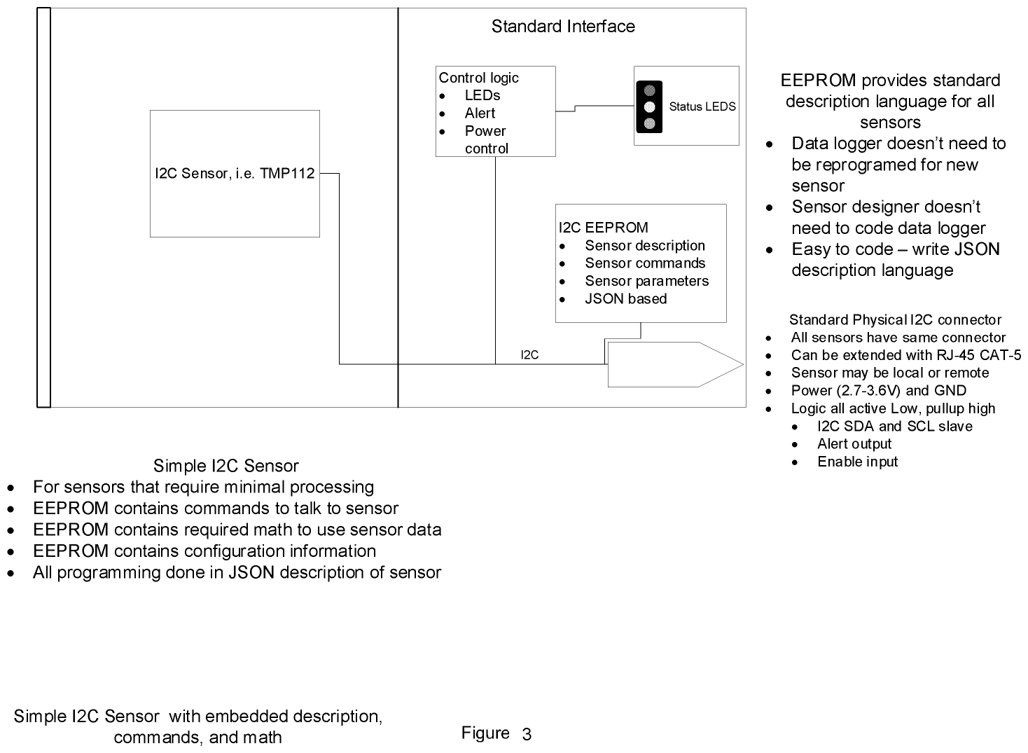

FIG. 3 shows a simple I2C sensor element as it would be designed according to the present invention. Here there is no need for an ADC since the I2C sensor performs data conversion to digital internally. The other blocks are the same as for the analog sensor shown in FIG. 2.

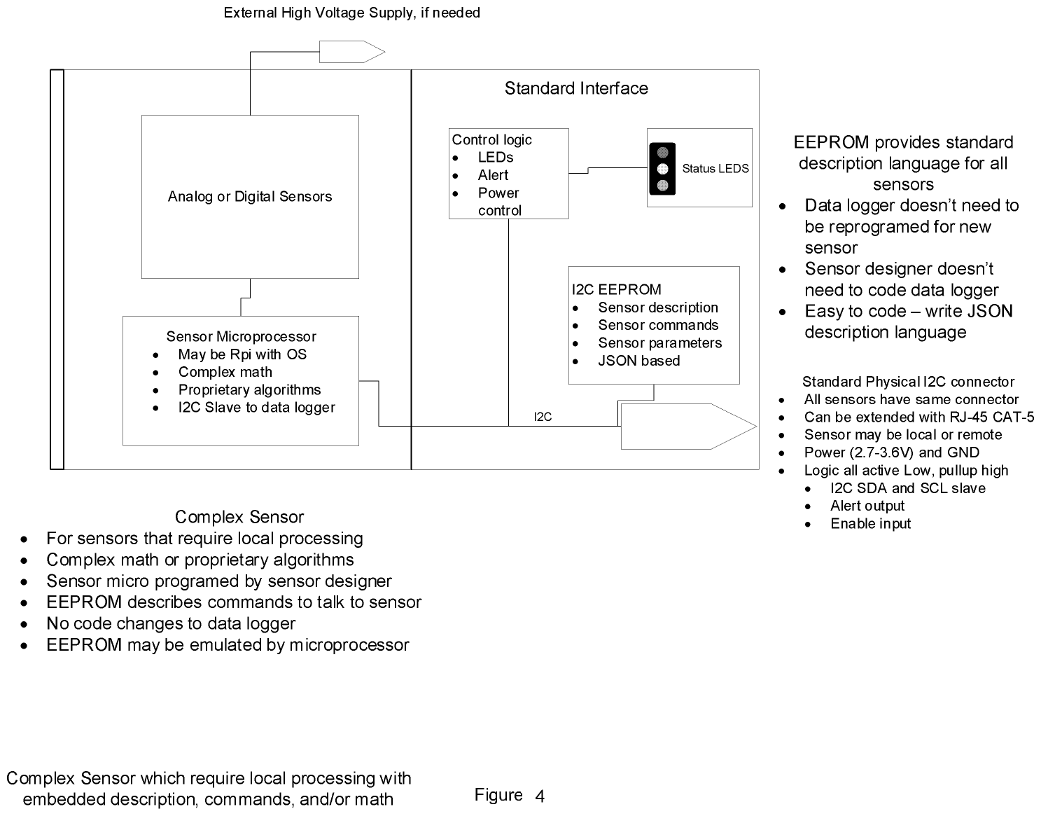

FIG. 4 represents a complex physical sensor element that must have local processing due to complex math, the shielding of proprietary algorithms, critical timing for which the interface is too slow, or other reasons. This type of sensor has a microprocessor or microcontroller onboard. The sensor block may have an analog or digital output to the microprocessor. If analog, the microprocessor may perform analog to digital conversion, or there may be an optional ADC block. Local electronic storage may be implemented in an electronic memory as in FIG. 2, or the local microprocessor may emulate the local electronic storage. The other blocks are the same as for an analog sensor such as that shown in FIG. 2.

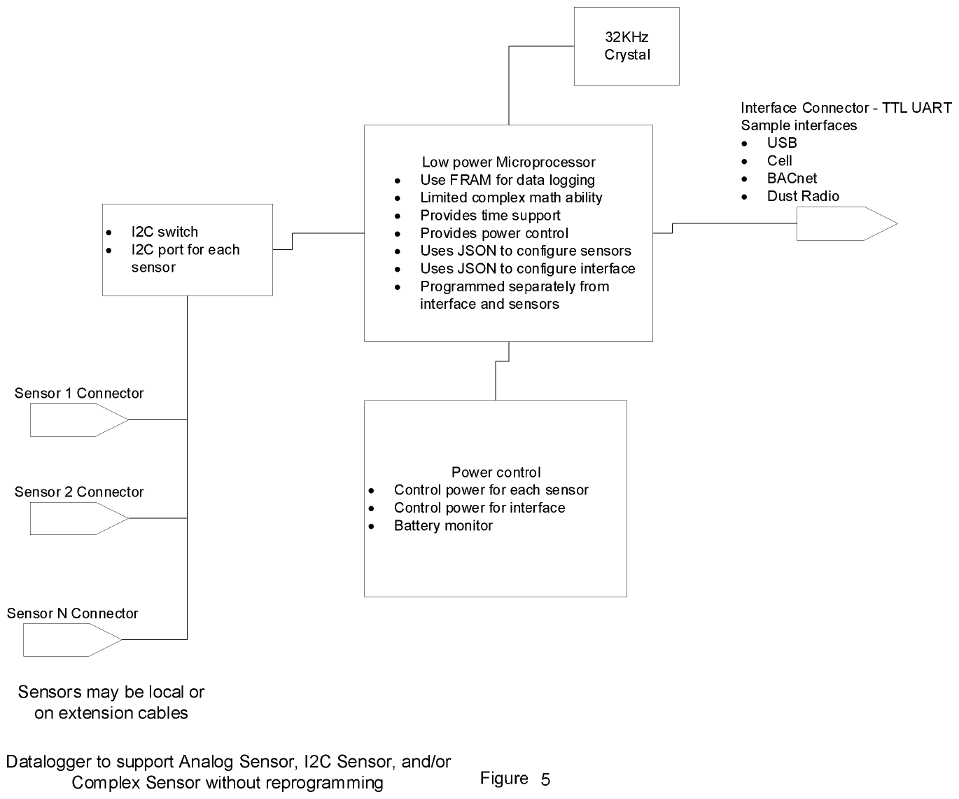

FIG. 5 illustrates a specific layout of a data logger working with I2C-based physical sensor elements. The data logger includes an I2C switch that can select various ports attached to sensor elements. A simple microprocessor generally provides data logging, some limited complexity mathematics and time support. Local electronic storage is provided by the microprocessor including all elements described in FIG. 2. Its output drives a USB port, cellular telephone interface, BACnet interface or radio interface. This data logger can support all previously described sensor types including analog, I2C or complex sensor types.

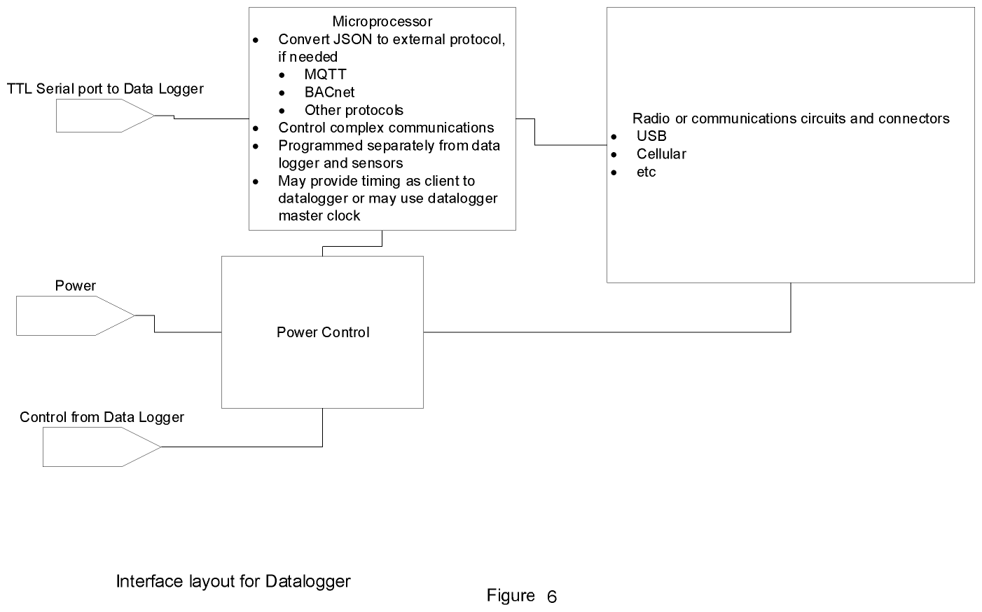

FIG. 6 shows a specific layout of an interface element for a data logger. This interface uses a microprocessor to provide external communication protocols including radio, cellular telephone, USB as required. An interface such as this may provide timing to a client such as a data logger, or may receive timing from a client. This interface is typically programmed separately from the data logger (or other client).

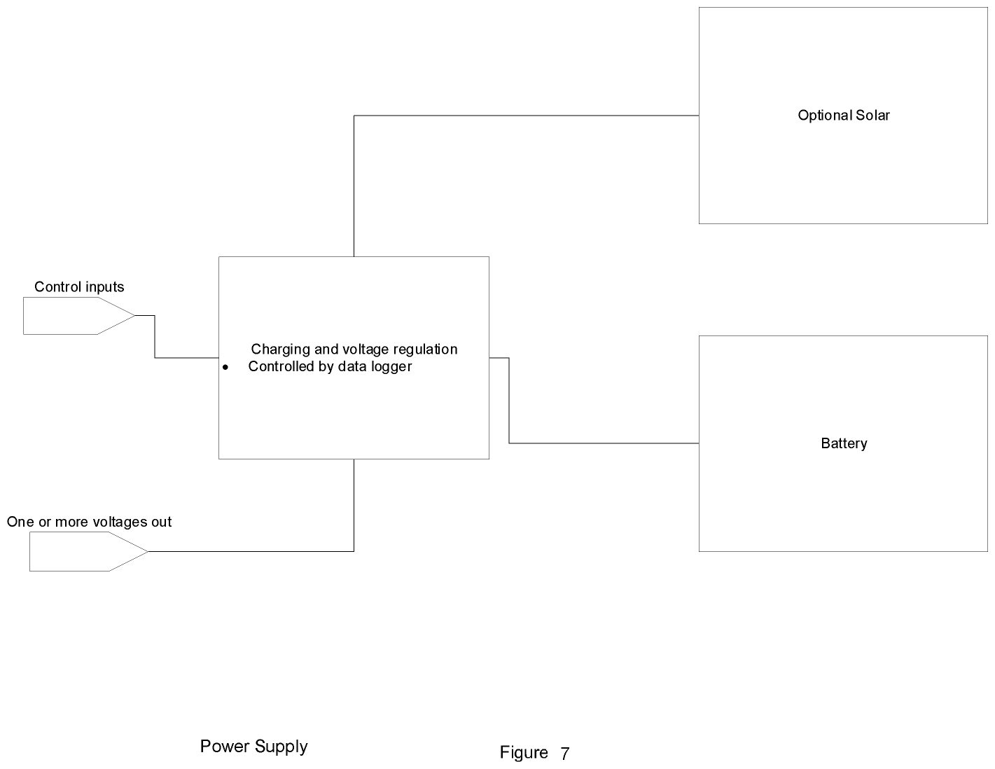

FIG. 7 shows the power layout of a cellular data logger device. The power may be battery, line, solar or any other. Typically, the charging function can be controlled by the data logger, as well as voltage regulation. Optionally, these functions can be part of the power layout.

FIG. 8 is a block diagram of a USB data logger denoting client and server relationships between elements. FIG. 8 is an example of an embodiment that has a temperature and humidity sensor element that allows measurement of temperature, humidity and corrosion. The sensor elements (such as those shown in FIGS. 2-4) are operationally connected to a physical interface protocol such as I2C. This physical interface provides communication into a microprocessor that contains data storage (which can be onboard, or in the form of a data storage element). The microprocessor communicates with a second physical interface that converts signals to protocols (such as serial) that can drive external devices such as computers. FIG. 8 shows a USB interface element for this function. FIG. 8 also shows the server/client relationships. The temperature and humidity sensor element is a server for the microprocessor and data storage element. The corrosion and temperature sensor element is also a server for the microprocessor and data storage element. The microprocessor and data storage element is a client of the temperature and humidity sensor element and a client of the corrosion sensor element, while it is a server for the USB interface element. The USB interface element is a client of the microprocessor and data storage element and a server to other network elements or programs.

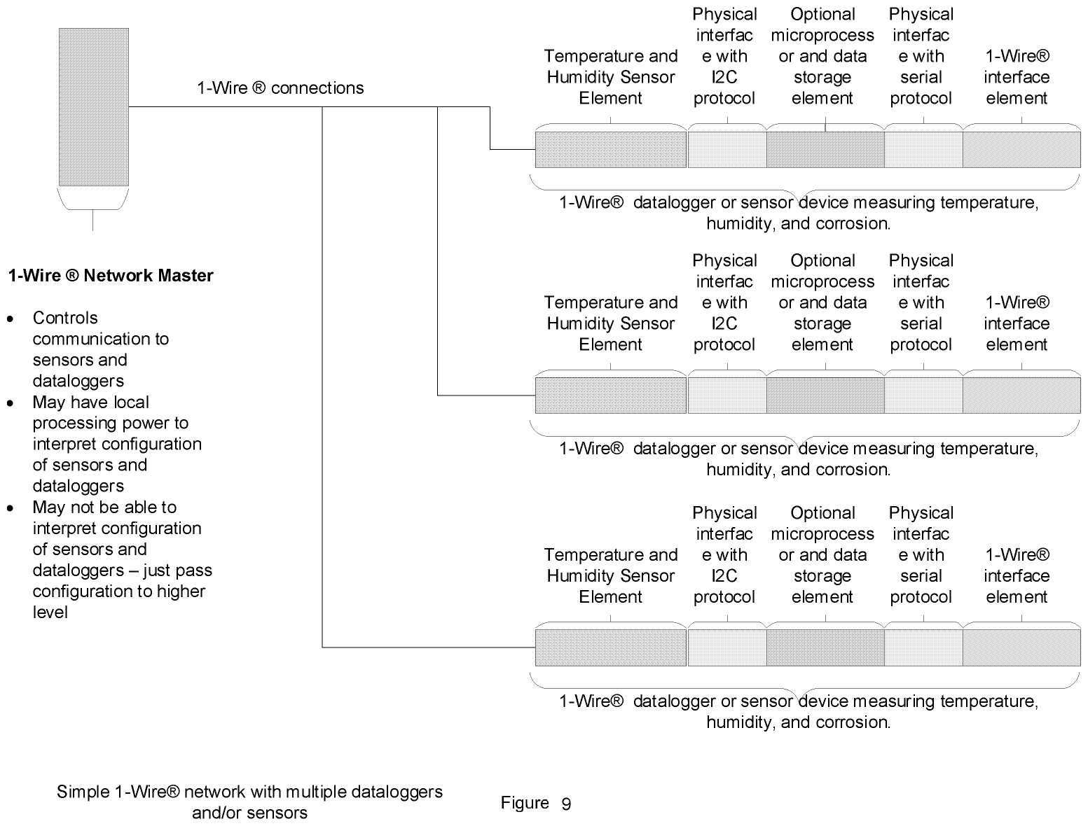

FIG. 9 illustrates a network of sensors comprised of multiple 1-Wire® sensors. FIG. 9 shows three 1-Wire® data loggers. These data loggers are similar to the data logger shown in FIG. 8, except that each data logger includes a 1-Wire® interface.

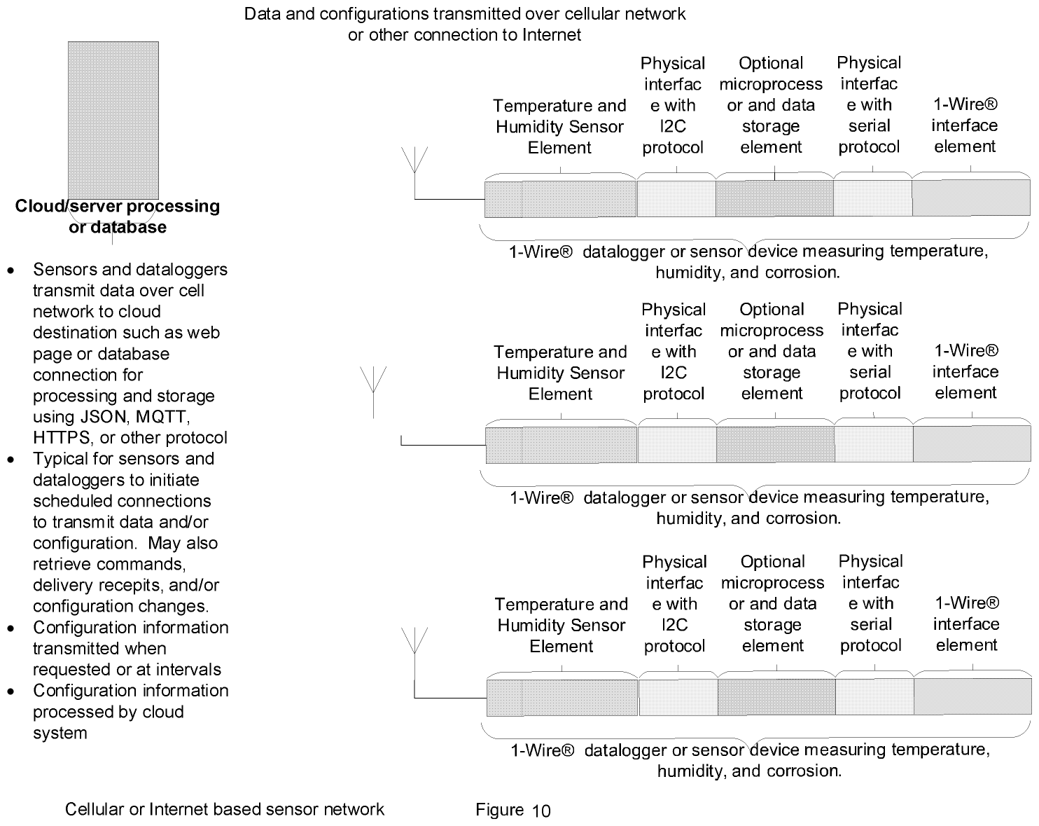

FIG. 10 shows a network of sensors including one or more data loggers or sensors connected to an Internet or cloud server/database via cellular, WiFi, Ethernet, or similar connection medium. For example, sensors and data loggers can transmit data over a cellular network to a cloud destination. The connections may be continuous, or more likely, scheduled. They many use any network protocol. Configuration information is transmitted when requested, or optionally at intervals. Typically, the configuration information is processed by the cloud system.

Several descriptions and illustrations have been presented to enhance understanding of the present invention. One skilled in the art will know that numerous changes and variations are possible without departing from the spirit of the invention. Each of these changes and variations are within the scope of the present invention.

1. A hierarchical network of elements comprising:
one or more physical elements, wherein each of the one or more physical elements includes internal storage that contains configuration information for that element, commands that can be executed by that element, results that can be supplied by that element, and mathematical procedures or data necessary to supply said results.

2. The hierarchical network of claim 1 wherein the one or more physical elements includes a sensor element.

3. The hierarchical network of claim 2 wherein the mathematical procedures and data contained in the internal storage allow the sensor to convert a raw measurement of a physical parameter to the results supplied by the sensor.

4. The hierarchical network of claim 2 wherein an element higher in the hierarchical network requests a physical parameter from a sensor that is lower in the hierarchical network.

5. The hierarchical network of claim 1 wherein a particular element is a derived sensor that requests a set of measurement data from a particular group of other elements upon command from a requesting element, combines data from the set of measurement data into a result using procedures and data stored in its internal storage, and then supplies the result to the requesting element.

6. The hierarchical network of claim 5 wherein the requesting element is higher in the hierarchical network than the derived sensor, and each element of the particular group of other elements is lower in the hierarchy.

7. The hierarchical network of claim 5 wherein the derived sensor is a dew point sensor that combines data from an element that is a temperature sensor and an element that is a humidity sensor.

8. The hierarchical network of claim 5 wherein the derived sensor is a corrosion sensor.

9. The hierarchical network of claim 1 wherein the one or more physical elements includes an alarm element.

10. The hierarchical network of claim 5 wherein at least one derived sensor is an alarm element, and the alarm element may control an output device.

11. The hierarchical network of claim 10 wherein the output device is an LED indicator.

12. The hierarchical network of claim 11 wherein the LED indicator is part of the alarm element.

13. The hierarchical network of claim 10 wherein the output device is an air conditioning unit.

14. The hierarchical network of claim 1 wherein elements in the hierarchical network communicate using a standard language.

15. A network of physical elements comprising:
one or more elements on a network, wherein each element includes internal storage that contains configuration data for that element, commands executable by that element and procedures and data needed by that element to supply a commanded result to another element on the network.

16. The network of claim 15 wherein there is a plurality of elements, and the plurality of elements is hierarchical such that elements higher in the hierarchy command elements lower in the hierarchy to perform functions or supply results.

17. The network of claim 15 wherein at least one element is a sensor element.

18. The network of claim 15 wherein at least one element is an alarm element.

19. The network of claim 15 wherein at least one element is a data logger.

20. The network of claim 15 wherein at least one element is a derived sensor, the derived sensor configured to request results from a predetermined group of other elements, combine the results from the predetermined group other elements, and using mathematical procedures and data stored in the derived sensor, produce a result.

21. The network of claim 20 wherein the predetermined group of other elements are lower or equal in the hierarchical network as the derived sensor.

22. A hierarchical network of elements containing a derived sensor comprising:
a plurality of hierarchical physical elements;
at least one element of said plurality being a derived sensor, wherein, the derived sensor is configured that upon command from a first element higher or equal in the hierarchical network, it requests results from a group of second elements lower or equal in the hierarchical network, combines the results using mathematical procedures and data stored internally in the derived sensor, and supplies a result to the first element.

23. The hierarchical network of claim 22 wherein the derived sensor is a dew point sensor.

24. The hierarchical network of claim 22 wherein the derived sensor is a corrosion sensor.

25. The hierarchical network of claim 22 further comprising a first derived sensor configured to request a first result from a second derived sensor and also to request a second result from at least one other element in the network to provide a third result to a requesting element by combining the first and second results using mathematical procedures and data stored internally in the first derived sensor.

26. A system of physical elements comprising:
a plurality of physical elements, wherein each element includes internal storage that contains configuration information for that element, commands that can be executed by that, results that can be supplied by that element, any mathematical procedures or data necessary to supply the results; and
wherein the plurality of physical elements includes a derived sensor configured to request a first result from a first element and also to request a second result from a second element in the network to provide a third result to a requesting element by combining the first and second results using mathematical procedures and data stored internally in the derived sensor.
